(19) United States
(12) Patent Application Publication
(10) Pub. No.: US 2002/0051163 A1
(43) Pub. Date: May 2, 2002

(54) Printer apparatus and printer control method

(75) Inventor: Kiyoaki Fujikura, Yokohama (JP)

Correspondence Address: ARMSTRONG,WESTERMAN & HATTORI, LLP, 1725 K STREET, NW., SUITE 1000, WASHINGTON, DC, 20006, US

(73) Assignee: Fujitsu Limited, Kawasaki, Japan

(21) Appl. No.: 09/822,231

(22) Filed: Apr. 2, 2001

(30) Foreign Application Priority Data
Oct. 26, 2000 (JP) 2000-326811

(51) Int. Cl. G06F 15/00

(52) U.S. Cl. 358/1.12

(57) ABSTRACT

The printer prints in logical-page units, and is capable of printing a plurality of logical pages on the same physical page when printing a plurality of logical pages on one physical page. This printer apparatus comprises: a mechanical controller for receiving printing commands and controls the printing engine that prints on the printing medium; and a printer controller for receiving printing instructions from the host to print in logical-page units and creating printing data. The printer controller calculates the total physical length of the logical-pages after creating the printing data, then references the physical length of one page of the printing medium, and depending on the results, sends a printing command and the printing data to the mechanical control unit, and also according to the reference results, controls the detection operation of the mechanical controller for detecting when there is no printing medium.

### BACKGROUND OF THE INVENTION

1. Field of the Invention

This invention relates to a printer apparatus and a printer control method for printing in logical-page units that are operated by the host, and more particularly to a printer apparatus and a printer control method that prints a plurality of pages of host data on one page of paper.

2. Description of the Related Art

FIG. 8 is a schematic drawing of a prior printer system. A host computer 1 sends data to be printed in page units (called logical page units) that are operated by the host 1. A printer apparatus 2 receives the printing data in logical-page units and performs the printing operation in logical-page units to print the data on the paper (continuous paper).

This continuous-paper printer apparatus 2, which prints in page units, comprises a printer controller 2-1, which analyzes the commands and data that are sent from the host computer 1 and creates a bit map for one page, a mechanical controller 2-2, which mainly controls the mechanical mechanism (printing engine) 2-3, and the mechanical mechanism (printing engine) 2-3 which performs actual printing in page units.

The host 1 sends a notification to the printer 2 giving the logical-page length and the printing data, the printer 2 creates bitmap data for the logical-page length and prints on the continuous paper in logical-page units. FIG. 9 shows an example of printing performed by the continuous-paper printer 2, and since in this example, the logical-page length (11 inches in the example) matches the fold length (11 inches) for the continuous paper that is set for the continuous-paper printer apparatus 2, one page of host data is properly printed on one page of paper.

FIG. 10A and FIG. 10B also show printing example that were printed by the continuous-paper printer 2, and these example differ from the example given in FIG. 9 in that the logical-page length from the host does not match the fold length (11 inches in this example) of the continuous paper. In FIG. 10A the fold length of the continuous paper is an integral multiple of the logical-page length from the host, and in FIG. 10B, the fold length of the continuous paper equals two pages of the logical-page length from the host (7 inches, 4 inches).

In this case as well, two pages of host data are simply printed on one sheet of paper, and as long as a sheet empty error does not occur, the data are printed with no problem.

By starting and performing the printing operation in logical-page units from the host, the host is not just limited to page units that are equal to the physical-page length of the printer, but it possible to create printing data with an arbitrary logical-page length, and thus increase the flexibility for creating printing data. For example, it is possible to print three logical pages, such as delivery statement, invoice and duplicate copy, on one sheet of paper.

FIG. 11A and FIG. 11B are drawings explaining the problem to be solved by this invention. A printer that is started for logical-page unit, performs printing in logical-page lengths (5.5 inches in this example), so operator errors, such as a ‘paper out’ error, are also detected in logical-page length units.

Therefore, as shown in FIG. 11A and FIG. 11B, when printing a plurality of logical pages on one physical page, logical pages 1 to 3 are printed normally, however when trying to print the fourth logical page, a ‘paper out’ error is detected, so the printer does not print but is in the ‘Call Operator’ state. After paper is supplied and printing is restarted, the fourth logical page is not printed on the sheet of paper (physical page) with the third logical page, but is printed on another sheet of paper (physical page). Each of the logical pages are printed, however, there is a problem when group of host data, which first have meaning when the data of two logical pages are printed on one sheet of paper (such as for a grouping like an invoice/duplicate copy), are printed on separate sheets of paper.

A printer that only prints in physical-page units combines a plurality of pages and activates printing in one physical-page unit (for example, as disclosed in Japanese Laid-open patent No. S61-11843, Japanese Laid-open patent No. H5-96833 and Japanese Laid-open patent No. H11-115259). This kind of printer originally creates printing data in physical-page units. So when a ‘Paper Out’ error occurs while printing one page, it is possible to prevent printing data for a plurality of pages from being printed on separate physical pages by printing again the printing data that have been created in physical page units.

However, when this method is applied to a printer which prints in logical-page units, it is necessary that the host notifies the printer of the number of logical pages for one physical page, or it is necessary to fix the number of logical pages for one physical page. Therefore it is necessary to change the host sequence, or it is not possible to take advantage of flexibility of using special logical-page unit.

### SUMMARY OF THE INVENTION

The object of this invention is to provide a printer apparatus and a printer control method that prevents logical-page data from being printed on separate physical pages even when a ‘Paper Out’ error occurs.

Another object of this invention is to provide a printer apparatus and a printer control method that prevents logical-page data from being printed on separate physical pages without changing the host sequence when a ‘Paper Out’ error occurs.

Still another object of this invention is to provide a printer apparatus and a printer control method that prevents logical-page data from being printed on separate physical pages while at the same time maintains the flexibility of logical pages when a ‘Paper Out’ error occurs.

In order to accomplish these objectives, the printer apparatus of this invention, which is specified by the host to print in logical-page units, comprises: a mechanical control unit for receiving printing commands and controlling a printing engine that prints on the printing medium; and a printer control unit for receiving a printing instruction from the host to print in logical-page units and creates printing data; and wherein the printer control unit calculates the total physical length of the logical-pages after creating printing data, then references the physical length of one page of the printing medium, and depending on the results, sends a printing command and printing data to the mechanical control unit, and also according to the reference results, controls the detection operation of the mechanical control unit for detecting when there is no printing medium.

In this invention, the printer controller recognizes one physical length of the printing medium, even when the host specifies to print in logical-page units, and activates the printing operation in logical-page units. Furthermore, the printer controller controls detection operation of whether or not there is printing medium with one physical page units of the printing medium. Therefore it is possible to prevent printing of a plurality of logical-page host data that should fit on one page, on separate pages. In addition, the host does not need to specify the number of logical pages that can fit within one page length of the printing medium, so it is possible to execute this calculation on the printer side without changing the host program.

Moreover, in a preferable embodiment of this invention, the printer controller creates bitmap data for each logical page as printing data according to the printing instruction from the host for printing in logical-page units until the total physical length of the plurality of logical pages reaches the physical length, and then sends a print command and the bitmap data in logical-page units to the mechanical control unit. Therefore printing can be performed without changing the printing process in logical-page units.

Furthermore, in a preferable embodiment of this invention, the printer control unit receives the logical-page lengths from the host and calculates the total physical length of the logical-page lengths. Therefore, it is capable of simply recognizing the relationship between the logical-page length and the physical-page length before printing one page.

Furthermore, in a preferable embodiment of this invention, the printer control unit is capable of simply recognizing the relationship between the logical-page length and the physical-page length before printing one page, by calculating the physical length of the total logical pages, according to the logical-page lengths and number of logical pages received from the host.

Moreover, in a preferable embodiment of this invention, the printing engine can print on a continuous printing medium having a set fold length, and thus can be applied to a high-speed printer as well.

### BRIEF DESCRIPTION OF THE DRAWINGS

FIG. 1 is a system diagram of an embodiment of the invention.

FIG. 2 is a schematic diagram of the printing engine of the system shown in FIG. 1.

FIG. 3 is a schematic diagram of the feed-information control unit shown in FIG. 1.

FIG. 4 is a flowchart showing the process flow of the printer controller shown in FIG. 1.

FIG. 5 is a flowchart showing the process flow of the mechanical controller shown in FIG. 1.

FIG. 6 is a block diagram of another embodiment of the feed-information control unit shown in FIG. 1.

FIG. 7 is a flowchart showing the process flow of the printer controller of the embodiment shown in FIG. 6.

FIG. 8 is system diagram of a prior printer system.

FIG. 9 is a drawing explaining a prior printing example.

FIGS. 10A and 10B are drawings explaining a prior example of printing a plurality of pages.

FIGS. 11A and 11B are drawings explaining the problems with the prior art.

### DETAILED DESCRIPTION OF THE PREFERRED EMBODIMENTS

The preferred embodiments of the invention will be explained below based on the drawings and in the order of the printing apparatus and then another embodiment.

[Printing Apparatus]

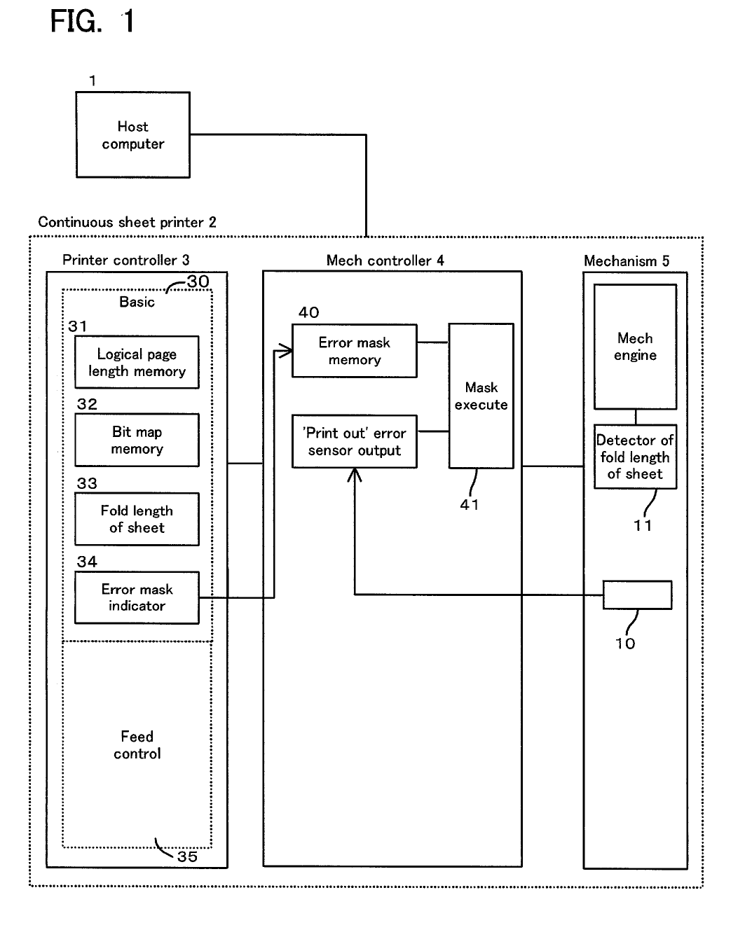

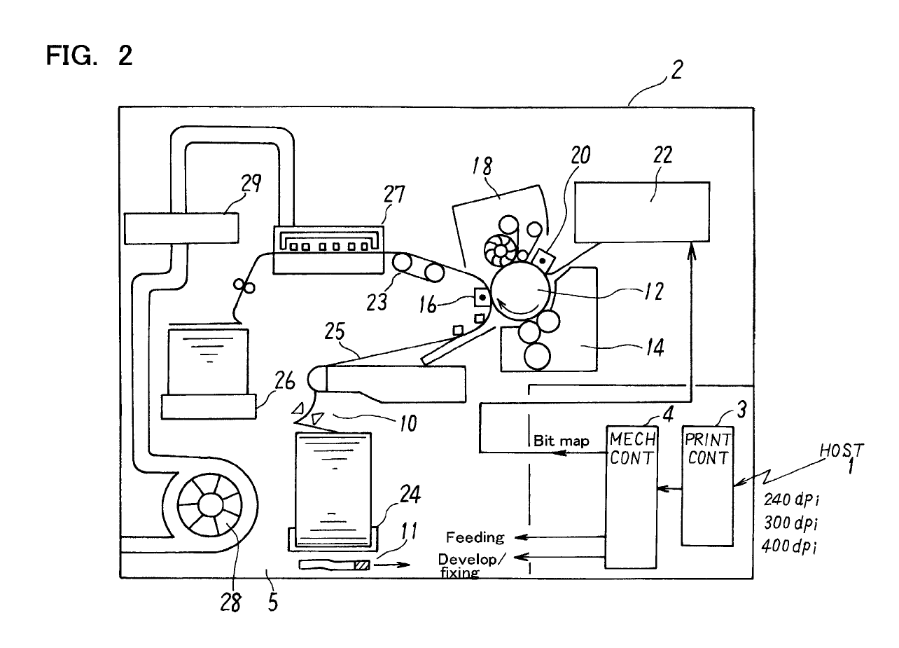

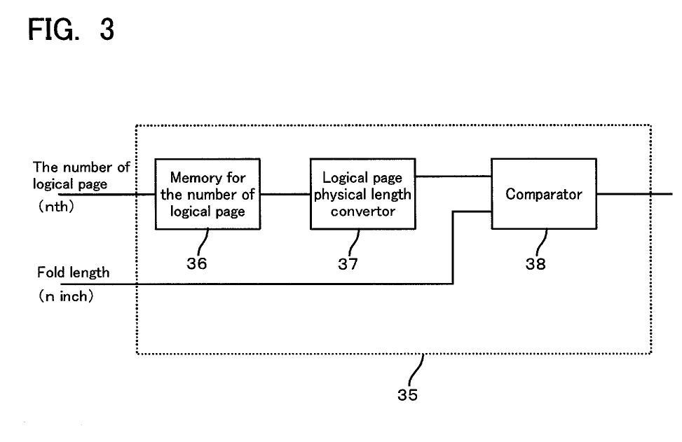

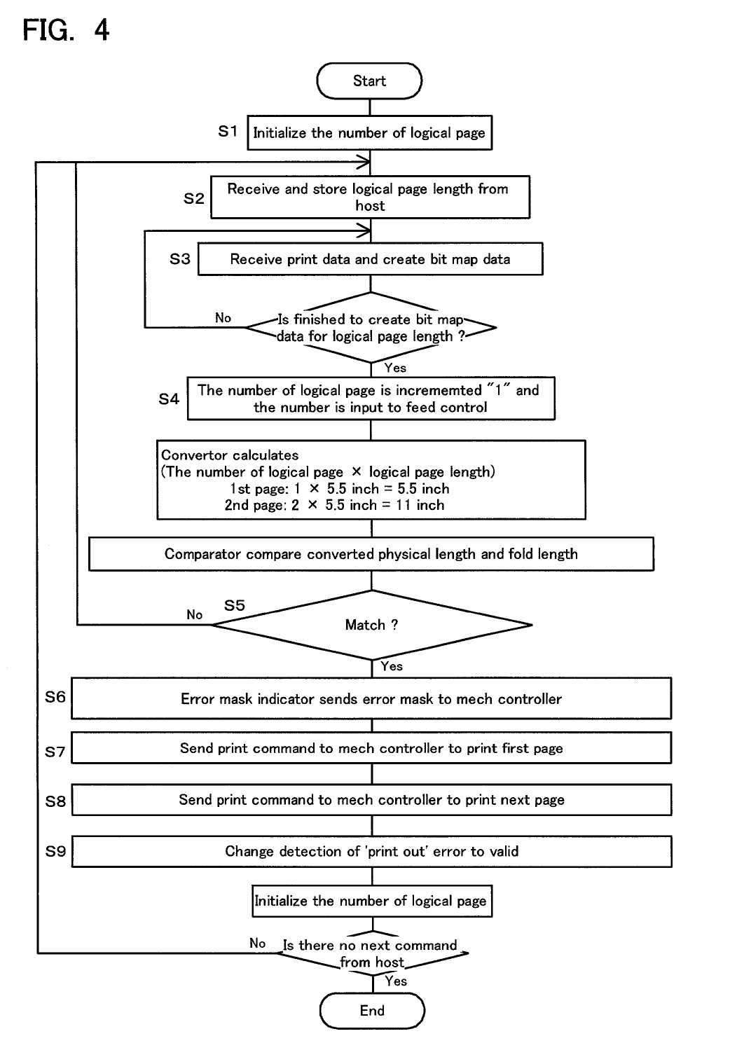

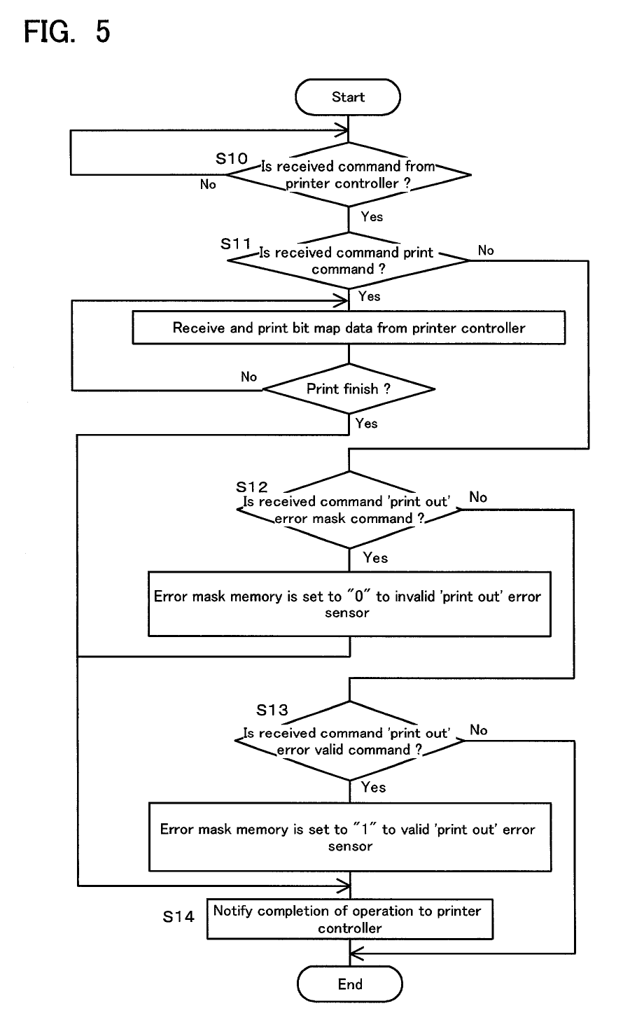

FIG. 1 is a block diagram of the printing apparatus of an embodiment of this invention, FIG. 2 is a schematic drawing of the embodiment shown in FIG. 1, FIG. 3 is a functional block diagram of the feed-information control unit shown in FIG. 1, FIG. 4 is a flowchart showing the process flow of the printer controller shown in FIG. 1, and FIG. 5 is a flowchart showing the process flow of the mechanical controller shown in FIG. 1.

As shown in FIG. 1, a host 1 sends printing data in page units (called logical-pages) of the host management to a printer 2. The printer 2 receives the printing data that are in logical-page units, and performs printing in logical-page units to print on the paper (continuous paper).

This continuous-paper printer 2, which prints in logical-page units, comprises: a printer controller 3, which analyzes the commands and data that are sent from the host 1 and creates bitmap data for one page; a mechanical controller 4, which controls the main mechanical mechanism unit (printing engine) 5; and the mechanical mechanism unit (printing engine) 5, which performs the actual printing in page units.

The printing engine 5 of the printer 2 will be explained using FIG. 2. The printer engine 5 comprises an electro-photographic mechanism. A photo-sensitive drum 12 is electrically charged by a charging unit 20, and then is exposed an image by a laser-exposure unit 22. A latent image is formed on the photo-sensitive drum 12 in this way. A developing unit 14 supplies a 2-component developer agent to the photo-sensitive drum 12 and develops the latent image into a toner image. A transfer unit 16 transfers the toner image on the photo-sensitive drum 12 to the sheet of paper 25. A cleaning mechanism 18 discharges the photo-sensitive drum 12 after the image has been transferred, and removes the remaining toner from the photo-sensitive drum 12.

The sheet of paper 25 is continuous paper and is held in a hopper 24. The sheet of paper 25 in the hopper 24 is led to the transfer position of the photo-sensitive drum 12 by a feed mechanism 23, and then is stored in a stacker 26 after passing a flash fixing device 27. The flash-fixation unit 27 fixes the toner image on the sheet of paper 25 by a flash of light.

This printer 2 is capable of a high-speed printing, for example, it is capable of printing 100 sheets per minute or more. Therefore, the amount of sublimate component of the toner due to flash fixation is large. To remove this sublimate component, there is a filter 29 and an exhaust fan 28.

It is possible to use an inorganic photo-sensitive material, such as amorphous silicone or selenium, or an organic photo-sensitive material, such as polysilane or phthalocyanine, for the photo-sensitive drum 12. From the aspect of long-life and durability, an amorphous silicone photo-sensitive drum is particularly preferred.

Moreover, in the printer engine 5, provided is a transmission-type sensor (‘paper out’ sensor) 10 for detecting whether or not there is continuous paper 25, located between the hopper 24 and the transfer position. Furthermore, provided is a sliding-type switch (paper fold length detection mechanism) 11, which sets the fold length (one page length) of the continuous paper 25 that is stacked in the stacker 26. For example, in the case where it is possible to stack 7 to 14-inch continuous paper in the stacker 26, the sliding-type switch 11 can be set at notches between 7 and 14 inches in increments of 0.5 inches.

The printer controller 3 of the printer 2 analyzes commands from the host 1 and generates internal commands and printing data (bitmap data). The mechanical controller 4 controls the feed mechanism 23 and developing/fixation mechanism 14, 16, 27 according to the internal commands. In addition, the mechanical controller 4 outputs the bitmap data to the exposure unit 22.

Returning to FIG. 1, the printer controller 3 comprises a basic control unit (program) 30 and feed-information control unit (program) 35. The basic control unit 30 comprises: a logical-page memory 31 for storing the logical-page lengths from the host 1; a bitmap memory 32 for storing the bitmap data, a paper-folding-length memory 33 for storing the paper folding length that was detected by the detection mechanism 11 of the engine 5, and an instruction unit 34 for issuing the ‘paper out’, error mask instruction.

As shown in FIG. 3, the feed-information control unit 35 comprises: a logical-page number memory unit 36 for storing the number of logical pages from the basic control unit 30, a conversion unit 37 which uses the logical-page lengths to convert the number of logical pages into a physical length (inches), and a comparison unit 38 which compares the paper fold length from the memory 33 with the physical length from the conversion unit 37, and generates a comparison output.

Returning to FIG. 1, the printer controller 3 analyzes commands and data sent from the host computer 1, as described later using FIG. 4, and continuous operating until the bitmap data for one logical page from the host has been completely created in the bitmap memory 32. After one logical page of bitmap data has been completely created, the printer becomes a status to print the bitmap data. However, the printer controller 3 does not immediately issue the print command, but references the feed information (comparison output) from the feed-information control unit 35 that is added to this invention. When the reference result is the top of the paper, then printer controller 3 waits until one more page of bitmap data is completely created, and after the second page of bitmap data has been completely created, the printer controller 3 activates printing for the first time.

As described later in FIG. 5, the mechanical controller 4 controls the engine 5 according to the printing command, to print the bitmap data. In addition, the mechanical controller 4 comprises a ‘paper out’ error mask instruction memory 40 and a mask execution unit 41 for calculating the logical sum of the error mask instruction and ‘paper out’ error sensor 10 output.

Next, FIG. 4 will be used to explain the printing process flow of the basic control unit 30 of the printer controller 3.

(S1) After receiving the job start command, the controller 3 initializes the internal number of logical pages to ‘0’.

(S2) The controller 3 receives the logical-page length from the host 1 and stores it in the logical-page-length memory 31.

(S3) The controller 3 receives printing data from the host 1 and creates bitmap data in the bitmap memory 32. The controller 3 then checks whether the bitmap data for the logical page from the host has been created, and creates the bitmap data for the logical page from the host.

(S4) The controller 3 increases the number of logical pages by an increment of ‘1’, to update the number of logical pages, then inputs that number to the feed-information control unit 35. The feed-information control unit 35 reads the logical-page length from the logical-page-length memory 31, and calculates the physical length (number of logical pages×logical-page length). The comparison unit 38 of the feed-information control unit 35 compares the converted physical length with the fold length stored in the memory 33.

(S5) The basic control unit 30 receives the comparison results, and in case there is not match, then returns to step S2.

(S6) When the comparison results match, the basic control unit 30 determines that the bitmap data for the fold length has been created, and moves to the printing activation process. First, the basic control unit 30 sends an instruction to the mechanical controller 4 by way of the ‘paper out’ error mask instruction, to perform the ‘paper out’ error mask. In this way, the mechanical controller 4 sets a mask flag in the error mask instruction memory 40.

(S7) The basic control unit 30 sends a printing command and the bit map data of the first logical page (for example 5.5 inches) to the mechanical controller 4, and as explained in FIG. 5, prints the first page.

(S8) The basic control unit 30 then sends a printing command and the bit map data of the next page (for example 5.5 inches) to the mechanical controller 4, and as explained in FIG. 5, prints the next page.

(S9) The basic control unit 30 then sends a reset command to the mechanical controller 4 to reset the mask flag in the error-mask instruction memory 40, and enables detection of the ‘paper out’ error. The basic control unit 30 then initializes the number of logical pages to ‘0’. The basic control unit 30 checks whether the next command has been sent from the host, and when the next command has been sent the main control unit 30 returns to step S2. In the case that the next command has not yet been sent, operation ends.

Next, the printing process of the mechanical controller 4 will be explained using FIG. 5.

(S10) The mechanical controller 4 checks whether a command has been received from the printer controller 3.

(S11) When a command has been received, the mechanical controller 4 determines whether the received command is a printing command. When the command is not a printing command, the mechanical controller 4 advances to step S12. When the received command is a printing command, the mechanical controller 4 receives bitmap data from the printer controller 3 and performs printing. After printing the specified bitmap is finished, the mechanical controller 4 advances to step S14.

(S12) The mechanical controller 4 determines whether the received command is a ‘paper out’ error mask command. When the received command is not a ‘paper out’ error mask command, the mechanical controller advances to step S13. When the received command is a ‘paper out’ error mask command, the mechanical controller 4 sets ‘0’ (error mask) in the ‘paper out’ error mask instruction memory 40 to enable the mask unit 41. Then the mechanical controller 4 advances to step S14.

(S13) The mechanical controller 4 determines whether the received command is a command to enable the ‘paper out’ error. When the error is not a command to enable the ‘paper out’ error, it is a command for another process, so the mechanical controller 4 ends this routine. When the command is a command to enable the ‘paper out’ command, the mechanical controller 4 set ‘1’ (‘error mask clear) in the ‘paper out’ error mask instruction memory 40, and disables the mask unit 41. The mechanical controller 4 then advances to step S14.

(S14) The mechanical controller 4 notifies the printer controller 3 that the operation has finished, and then ends the printing process routine.

In this way, the printer controller 3 analyzes the commands and data sent from the host, and creates bitmap data for one logical page from the host in the bitmap memory 32. After the bitmap for one logical page has been completely created, the printer becomes a status to be able this bitmap data. However the printer controller 3 does not issue a print command immediately, but references the feed information (comparison output) from the feed-information control unit 35, which is added to this invention. When the comparison result is that it is the top (start) of the paper, the printer controller 3 waits until completely creating one more page of bitmap data, and as soon as two pages of bitmap data have been completely created, the printer controller 3 activates the mechanical controller 4 for the first time to perform printing.

The mechanical controller 4 receives the bitmap data according to the printing command, and performs printing, so printing is performed in paper fold length units even though the host specifies printing in logical-page units, and thus it is possible to prevent a plurality of logical-page host data, that can fit on one page, from being printed on separate pages.

Moreover, the host does not need to specify the number of logical pages that should fit with in the paper-fold length, so the printing can be performed by the printer without having to change the host program. Furthermore, ‘paper out’ detection for each print command by the mechanical controller 4 is masked until printing is performed in fold-length units, and then ‘paper out’ error is detected in fold-length units, so it is possible to prevent a plurality of logical-page host data, which can fit on one page, from being printed on separate pages due to a ‘paper out’ error occurring.

By performing the operation of obtaining paper-feed information each time bitmap data are created for a logical page, it is possible to easily prevent logical-page host data from being printed on separate pages.

[Another Embodiment]

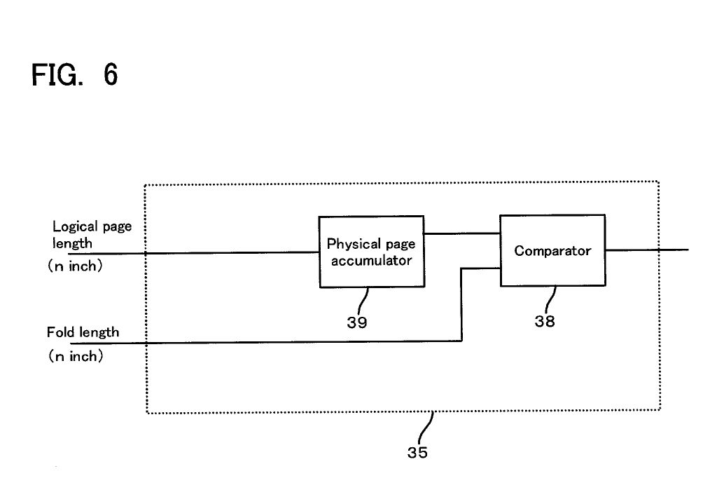

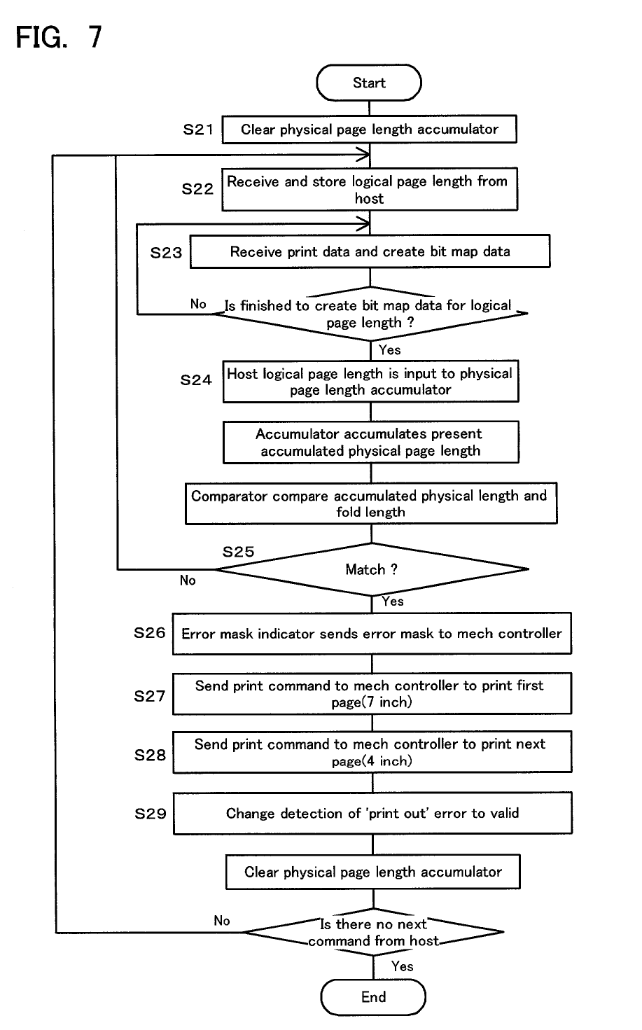

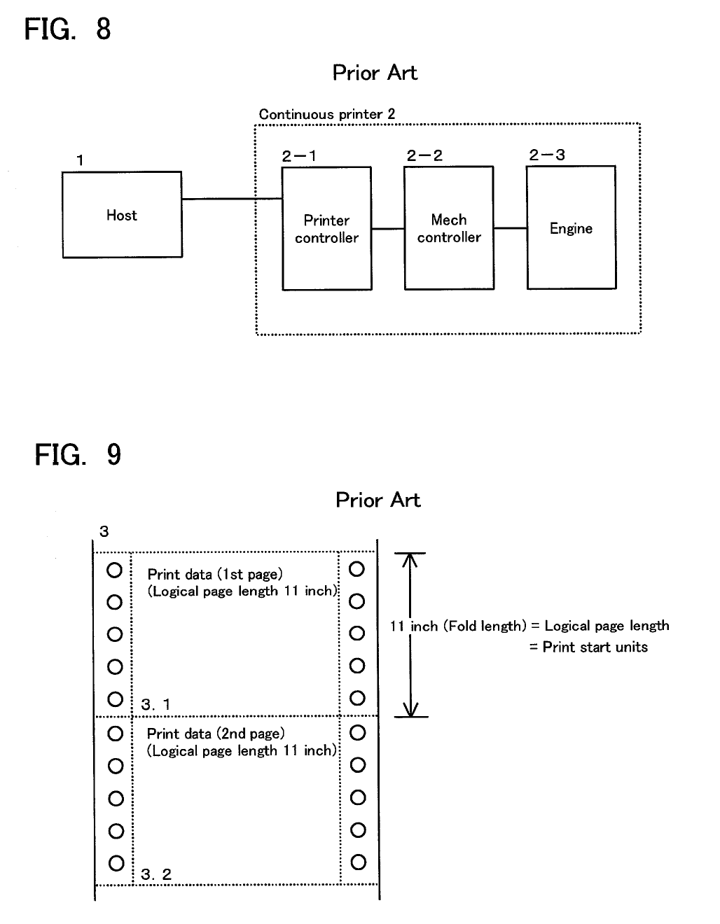

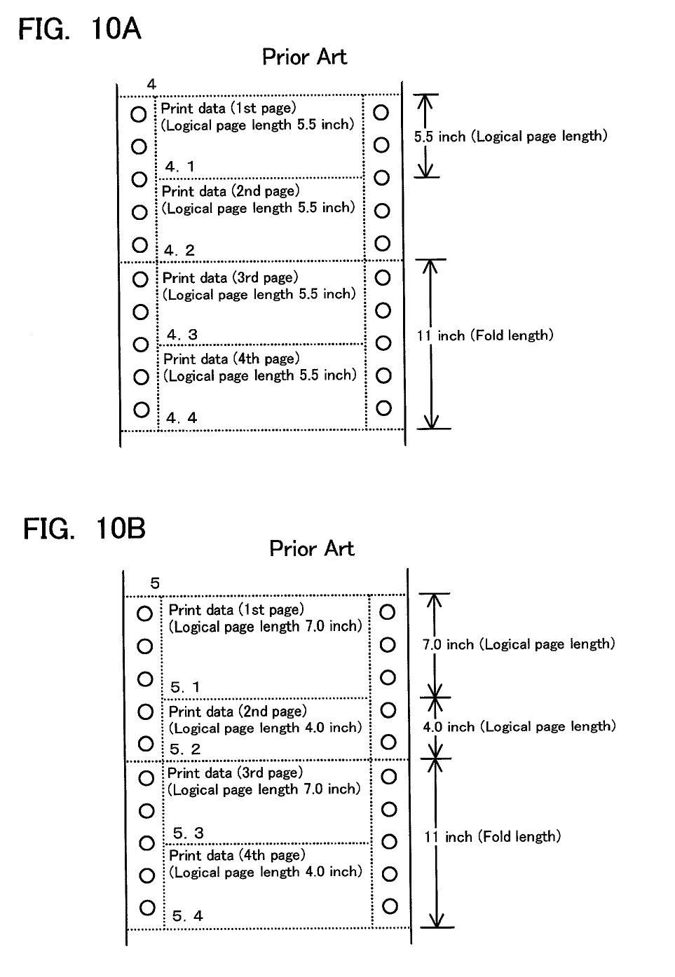

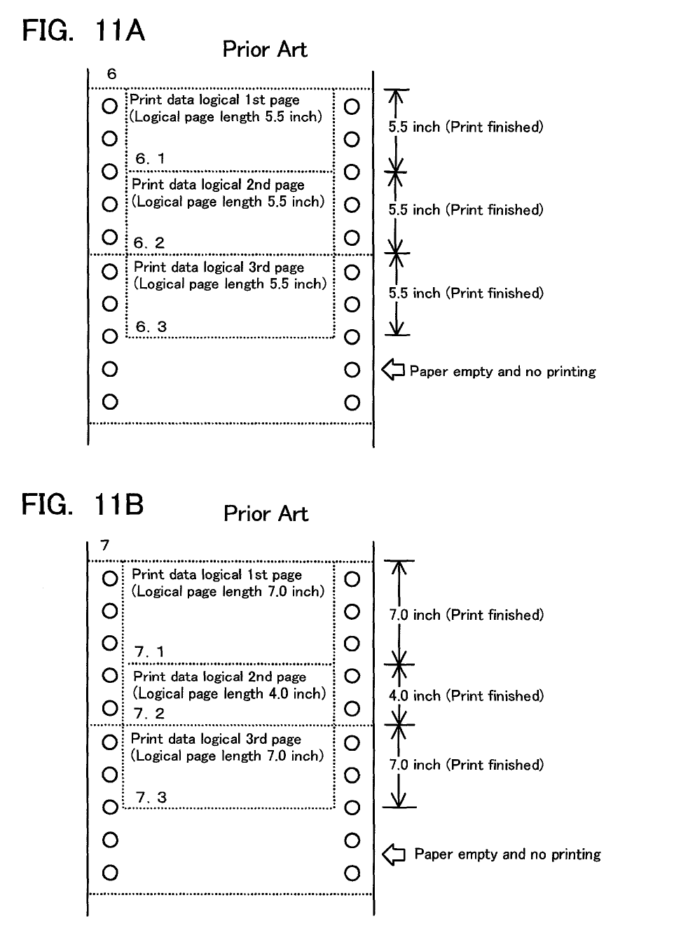

FIG. 6 is a schematic drawing of the feed-information control unit of another embodiment of the invention, and FIG. 7 is a flowchart showing the flow of the printing process of the printer controller of another embodiment of the invention.

As shown in FIG. 6, in this embodiment, the feed-information control unit 35 comprises: a summation unit 39, for obtaining the logical-page lengths from the basic control unit 30 and calculating the total as the physical page length; and a comparison unit 38 for comparing the total length from the summation unit 39 and the fold length.

Next, the flow of the printing process of the basic control unit 30 of the printer controller 3 of this embodiment will be explained using FIG. 7.

(S21) After receiving a job start command, the controller 3 clears the summation unit 39 of the feed-information control unit 35.

(S22) The controller 3 receives a logical-page length from the host 1 and stores it in the logical-page length memory 31.

(S23) The controller 3 receives printing data from the host and creates bitmap data in the bitmap memory 32. The controller 3 then checks whether bitmap data for the logical page of the host has been created, and creates bitmap data for a logical page of the host.

(S24) The basic control unit 30 inputs the logical-page length to the feed-information control unit 35. The feed-information control unit 35 calculates the total physical-page length up to that point by the physical-page-length summation unit 39, and then the comparison unit 38 of the feed-information control unit 35 compares the calculated physical length with the fold length in the memory 33.

(S25) The basic control unit 30 receives the comparison results, and when the comparison does not match, the basic control unit 30 advances to step S22.

When the comparison does match, the basic control unit 30 determines that bitmap data have been created for the fold length, and moves to the process to activate printing. First, the basic control unit 30 sends an instruction to the mechanical controller 4 by way of the ‘paper out’ error mask instruction unit 34 to mask ‘paper out’ error. By doing this, the mechanical controller 4 sets a mask flag in the error-mask-instruction memory 40.

(S27) The basic control unit 30 sends a printing command and the bit map data of the first logical page (for example 7 inches) to the mechanical controller 4, and as explained in FIG. 5, prints the first page.

(S28) The basic control unit 30 then sends a printing command and the bit map data of the next logical page (for example 4 inches) to the mechanical controller 4, and as explained in FIG. 5, prints the next page.

(S29) The basic control unit 30 issues a reset command to the mechanical controller 4 to reset the mask flag in the error-mask-instruction memory 40, and enables detection of the ‘paper out’ error. In addition, the basic control unit 30 clears the physical-page length summation unit 39 to ‘0’. The basic control unit 30 then checks whether the next command has been sent from the host, and when there is a command, advances to step S22. When there is no next command, the basic control unit 30 ends operation.

In this way, it is possible to print a plurality of logical pages in physical-page units even when the logical-page lengths of the logical page units differ, or in other words, when the lengths of the plurality of logical pages to be arranged on one physical page differ.

This invention has been explained for a continuous-paper type printer, however, it can similarly be applied to cut-paper type printer that receives printing commands from the host in logical-page units.

The preferred embodiments of the present invention have been explained, however the invention is not limited to these embodiments and can be embodied in various forms within the scope of the present invention.

(1) The present invention recognizes the length of one physical page and activates printing in logical-page units even when the host specifies printing in logical-page units, and controls the detection operation of whether or not there is printing medium in the print-activation units so as to perform in one-page units of the printing medium. Therefore, this invention makes it possible to prevent printing of a plurality of pages that can fit on one page, from being printed on separate pages, even when a ‘Printing Medium Out’ error occurs.

(2) Moreover, in this invention, it is not necessary for the host to specify the number of logical pages to print on one page length of printing medium. So, printing can be executed on the printer side without having to change the host program.

What is claimed is:

1. A printer apparatus, which is specified by the host to print in logical-page units, and comprises:
a mechanical controller for receiving a printing command, controlling a printing engine that prints on a printing medium, and detecting when there is no said printing medium in said printing engine; and
a printer controller for receiving a printing instruction from said host to print in logical-page units and creating printing data;
wherein said printer controller calculates the total physical length of said logical-pages after creating said printing data, then references a physical length of one page of said printing medium, and depending on the results, sends said printing command and said printing data to said mechanical controller, and also according to said reference results, controls the detection operation of said mechanical controller for detecting when there is no said printing medium.

2. The printer apparatus of claim 1, wherein p1 said printer controller creates bitmap data for each logical page as said printing data according to the printing instruction from said host for printing in logical-page units until the total physical length of plurality of said logical pages reaches said physical length, and then sends said print command and said bitmap data in logical-page units to said mechanical controller in said logical-page units.

3. The printer apparatus of claim 1, wherein
said printer controller receives the logical-page lengths from said host, and calculates the total physical length of said logical-pages.

4. The printer apparatus of claim 1, wherein
said printer controller calculates the physical length of said total logical pages, according to the logical-page lengths and number of logical pages received from said host.

5. The printer apparatus of claim 1, wherein
said printing engine comprises an engine for printing on a continuous printing medium, having a set fold length, as said printing medium.

6. The printer apparatus of claim 1, wherein
said printer controller checks said physical length in said logical-page units.

7. A printer control method for printing in logical-page units according to a command of a host, and comprises the steps of:
receiving a printing instruction from said host to print in logical-page units:
creating printing data to be printed on a print medium by a print engine according to said printing instruction;
calculating the total physical length of said logical-pages;
referencing a physical length of one page of said print medium;
sending a printing command and said printing data to mechanical controller for controlling said print engine according to said reference results and controlling the detection operation of said mechanical controller for detecting when there is no said printing medium.

8. The printer control method of claim 7, wherein
said creating step comprises a step of creating bitmap data for each logical page as said printing data according to the printing instruction from said host for printing in logical-page units until the total physical length of plurality of said logical pages reaches said physical length,
and said sending step comprises a step of sending said print command and said bitmap data in logical-page units to said mechanical controller in said logical-page units.

9. The printer control method of claim 7, wherein
said calculating step comprises a step of calculating the total physical length of said logical-pages according to logical-page lengths received from said host.

10. The printer control method of claim 7, wherein
said calculating step comprises a step of calculating the physical length of said total logical pages, according to the logical-page lengths and number of logical pages received from said host.

11. The printer control method of claim 7, wherein
said printing engine comprises an engine for printing on a continuous printing medium, having a set fold length, as said printing medium.

12. The printer control method of claim 7, wherein
said referencing step comprises a step of checking said physical length in said logical-page units.
